(19) United States
(12) Patent Application Publication
(10) Pub. No.: US 2017/0139115 A1
(43) Pub. Date: May 18, 2017

(54) LED LAMP ASSEMBLY, BACKLIGHT MODULE, AND DISPLAY DEVICE

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Zhishuai JIA, Tianjin (CN)

(21) Appl. No.: 15/239,375

(22) Filed: Aug. 17, 2016

Related U.S. Application Data
(63) Continuation of application No. PCT/CN2016/081947, filed on May 13, 2016.

(30) Foreign Application Priority Data
Nov. 13, 2015 (CN) 201510778257.4

(51) Int. Cl. F21V 8/00; H05B 33/08

(52) U.S. Cl. CPC G02B 6/0073; G02B 6/0085; H05B 33/089

(57) ABSTRACT

The disclosure provides an LED lamp assembly, a backlight module, and a display device. The LED lamp assembly includes a heat radiation substrate, and a plurality of LEDs arranged on the heat radiation substrate, wherein the LED lamp assembly further includes at least one pressure sensor arranged on the heat radiation substrate on the same side as the plurality of LEDs arranged on the heat radiation substrate, and a pressure bearing face of the pressure sensor protrudes above the plurality of LEDs.

### CROSS REFERENCE TO RELATED APPLICATIONS

This application is a continuation of International Application No. PCT/CN2016/081947, filed on May 13, 2016, which is based upon and claims priority to Chinese Patent Application No. 201510778257.4, filed on Nov. 13, 2015, the entire contents of which are incorporated herein by reference.

### TECHNICAL FIELD

The present disclosure relates to the field of display technologies, and particularly to an LED lamp assembly, backlight module, and display device.

### BACKGROUND

At present, a backlight module of a display device commonly includes Light Emitting Diodes (LEDs) operating as light sources, and the backlight module can be categorized into a straight down type backlight module and a side light type backlight module, dependent upon the positions where the light sources are distributed, where the side light type backlight module is further categorized into a one side light type backlight module and a two sides light type backlight module. An existing display device with a large size, e.g., a liquid crystal TV set with a large size, etc., typically includes a two sides light type backlight module, where light sources are arranged between light entrance end faces on two short sides of a light guide plate, and sidewalls of a back plate.

The two sides light type backlight module generally includes a back plate with an accommodating space; a reflecting sheet, a light guide plate, and an optical film sheet located and arranged in that order in the accommodating space of the back plate; two LED lamp assemblies located respectively between light entrance end faces on two short sides of the light guide plate, and sidewalls of the back plate; and a glue frame located above the optical film sheet and assembled with the back plate.

The light guide plate theoretically shall be positioned in the backlight module structured above, symmetric horizontally to the two LED lamp assemblies, but the light guide plate in the real product tends to be offset toward one of the LED lamp assemblies due to machining precision, positional precision, and other reasons, so that there may be a significant difference in brightness between the left and right sides of the backlight module, thus degrading an optical quality of the backlight module and the display device.

### SUMMARY

Embodiments of the disclosure provide an LED lamp assembly, a backlight component, and a display device so as to alleviate the difference in brightness between pictures throughout the backlight module and to improve an optical quality of the backlight module and the display device.

In one aspect, embodiments of the disclosure provides an LED lamp assembly including a heat radiation substrate, and a plurality of LEDs arranged on the heat radiation substrate, wherein the LED lamp assembly further includes at least one pressure sensor arranged on the heat radiation substrate on the same side as the plurality of LEDs arranged on the heat radiation substrate, and the pressure bearing face of the pressure sensor protrudes above the plurality of LEDs.

In another aspect, embodiments of the disclosure provides a backlight module including a back plate, a light guide plate, and two LED lamp assemblies, wherein each LED lamp assembly includes a heat radiation substrate, and a plurality of LEDs arranged on the heat radiation substrate, wherein the each LED lamp assembly further includes at least one pressure sensor arranged on the heat radiation substrate on the same side as the plurality of LEDs arranged on the heat radiation substrate, and the pressure bearing face of the pressure sensor protrudes above the plurality of LEDs, wherein:

the back plate includes an accommodating space in which the light guide plate is located, and the two LED lamp assemblies are located respectively between two opposite light entrance end faces of the light guide plate and sidewalls of the back plate; and

the pressure sensor in each LED lamp assembly is connected by a signal with a main board of a display device, and configured to transmit a trigger signal to the main board of the display device when a pressure is applied thereto from one of the light entrance end faces of the light guide plate; and if the main board of the display device receives the trigger signal transmitted by the pressure sensor in one of the LED lamp assemblies, but does not receive any trigger signal transmitted by the pressure sensor in the other LED lamp assembly, then the main board of the display device controls current in the other LED lamp assembly to be raised.

In a further aspect, embodiments of the disclosure provides a display device including a backlight module, wherein the backlight module includes a back plate, a light guide plate, and two LED lamp assemblies, wherein each LED lamp assembly includes a heat radiation substrate, and a plurality of LEDs arranged on the heat radiation substrate, wherein the each LED lamp assembly further includes at least one pressure sensor arranged on the heat radiation substrate on the same side as the plurality of LEDs arranged on the heat radiation substrate, and the pressure bearing face of the pressure sensor protrudes above the plurality of LEDs, wherein:

the back plate includes an accommodating space in which the light guide plate is located, and the two LED lamp assemblies are located respectively between two opposite light entrance end faces of the light guide plate and sidewalls of the back plate; and

the pressure sensor in each LED lamp assembly is connected by a signal with a main board of a display device, and configured to transmit a trigger signal to the main board of the display device when a pressure is applied thereto from one of the light entrance end faces of the light guide plate; and if the main board of the display device receives the trigger signal transmitted by the pressure sensor in one of the LED lamp assemblies, but does not receive any trigger signal transmitted by the pressure sensor in the other LED lamp assembly, then the main board of the display device controls current in the other LED lamp assembly to be raised. Since there are a smaller difference in brightness of pictures throughout, and a higher optical quality, of the backlight module, the display device will have a higher quality of display.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural top view of an LED lamp assembly according to an embodiment of the disclosure;

FIG. 2 is a schematic structural side view of an LED lamp assembly according to an embodiment of the disclosure;

FIG. 3 is a schematic structural side view of an LED lamp assembly according to another embodiment of the disclosure;

FIG. 4 is a schematic structural top view of a first assembled state of a backlight module according to an embodiment of the disclosure;

FIG. 5 is a schematic structural top view of a second assembled state of a backlight module according to an embodiment of the disclosure; and

FIG. 6 is a schematic structural top view of a third assembled state of a backlight module according to an embodiment of the disclosure.

### REFERENCE NUMERALS

101—Heat radiation substrate;

102—LED

103—Pressure sensor

200—Back plate

300—Light guide plate

100—LED lamp assembly

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

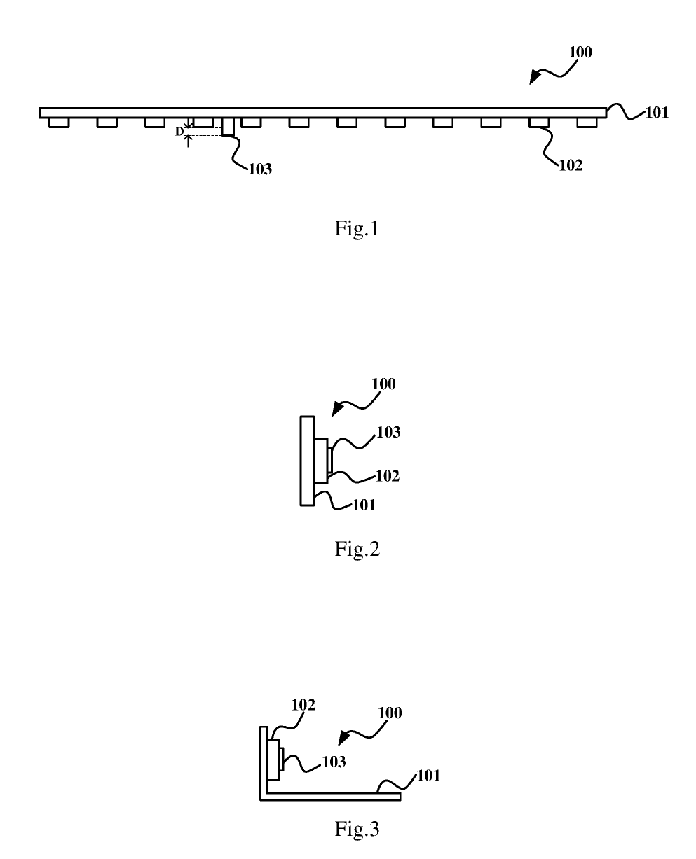

As illustrated in FIG. 1, an LED lamp assembly 100 according to an embodiment of the disclosure includes a heat radiation substrate 101, and a plurality of LEDs 102 arranged on the heat radiation substrate 101, and the LED lamp assembly 100 further includes at least one pressure sensor 103 arranged on the heat radiation substrate 101 on the same side as the plurality of LEDs 102 arranged on the heat radiation substrate 101, where the pressure bearing face of the pressure sensor 103 protrudes above the plurality of LEDs 102.

Here the heat radiation substrate 101 is typically an aluminous heat radiation substrate which will not be limited to any particular form, e.g., a flat heat radiation substrate illustrated in FIG. 2, an L-shaped heat radiation substrate illustrated in FIG. 3, etc. The pressure sensor 103 will not be limited to any particular type, e.g., a piezoresistive pressure sensor, a strain gauge pressure sensor, etc. The position where the pressure sensor 103 is arranged will not be limited to any particular position as long as it is arranged on the same side as the LEDs 102 and the pressure bearing face of the pressure sensor 103 protrudes above the LEDs 102, and optionally the pressure sensor 103 is arranged between two adjacent LEDs.

As illustrated in FIG. 1, in an optional embodiment of the disclosure, the difference D in height between the pressure bearing face of the pressure sensor 103 and the plurality of LEDs 102 optionally ranges from 0.2 mm to 0.5 mm, so that not only the accuracy and the sensitivity of detection by the pressure sensor 103 will not be degraded, but also light emitted by the LEDs 102 can be transmitted into the light guide plate as much as possible to thereby improve the utilization ratio of the light.

In the technical solution according to the embodiment above of the disclosure, the LED lamp assembly further includes the pressure sensor arranged on the same side of the LEDs, where the pressure bearing face of the pressure sensor protrudes above the plurality of LEDs. After such LED lamp assemblies are assembled into the backlight module, if the light guide plate is offset toward one of the LED lamp assemblies, then the pressure sensor on the same side as the LED lamp assembly can detect it in a timely manner, and transmit a trigger signal to a main board of a display device, and the main board of the display device can control current in the other LED lamp assembly to be raised as appropriate upon reception of the trigger signal to thereby maintain consistent brightness on both of the sides of the backlight module. This solution can alleviate the difference in brightness of pictures throughout the backlight module, and improve the optical quality of the backlight module and the display device, as compared with the prior art.

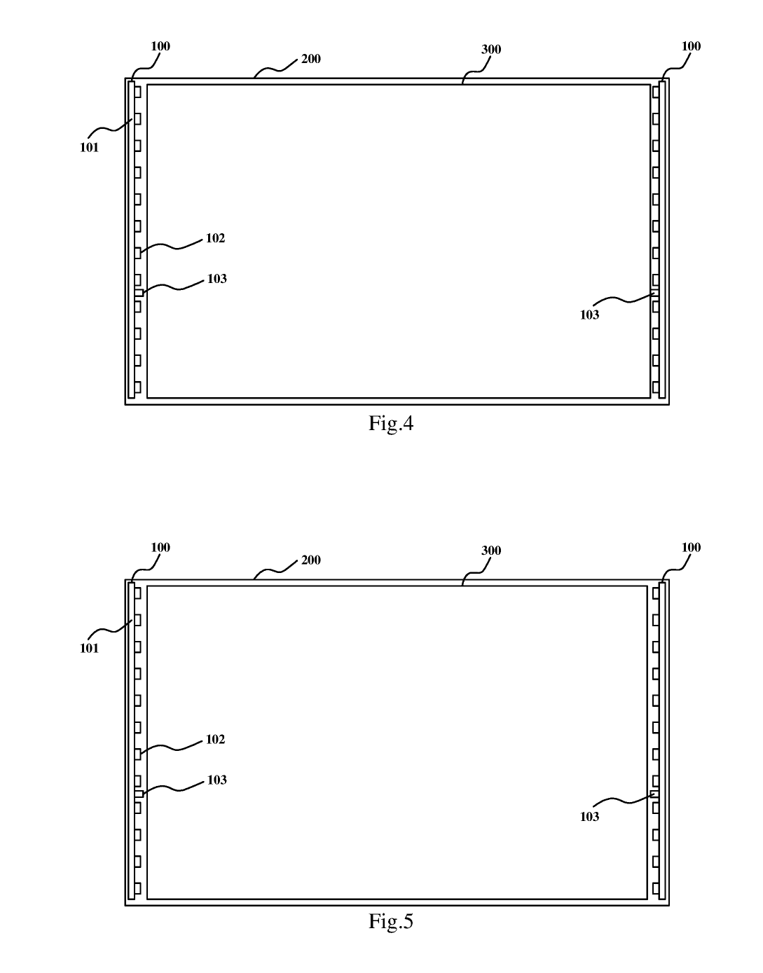

As illustrated in FIG. 4, an embodiment of the disclosure further provides a backlight module including a back plate 200, a light guide plate 300, and the LED lamp assemblies 100 according to the embodiment above, wherein:

The back plate 200 includes an accommodating space in which the light guide plate 300 is located, and two LED lamp assemblies 100 are located respectively between two opposite light entrance end faces of the light guide plate 300 and sidewalls of the back plate 200; and

The pressure sensor 103 in each LED lamp assembly 100 is connected by a signal with a main board of a display device, and configured to transmit a trigger signal to the main board of the display device when a pressure is applied thereto from one of the light entrance end faces of the light guide plate 300; and if the main board of the display device receives the trigger signal transmitted by the pressure sensor in one of the LED lamp assemblies (on the right as illustrated), but does not receive any trigger signal transmitted by the pressure sensor in the other LED lamp assembly (on the left as illustrated), then the main board of the display device may control current in the other LED lamp assembly to be raised.

In addition to the structural components above, the backlight module typically includes a reflecting sheet, an optical film sheet, a glue frame, etc. With the backlight module designed above, if the light guide plate is offset to one of the LED lamp assemblies due to machining precision, positional precision, or other reasons, then the pressure sensor on the same side as the LED lamp assembly can detect it in a timely manner, and transmit a trigger signal to the main board of the display device, and the main board of the display device can control current in the other LED lamp assembly to be raised as appropriate upon reception of the trigger signal to thereby maintain consistent brightness on both of the sides of the backlight module. This solution can alleviate the difference in brightness of pictures throughout the backlight module, and improve the optical quality thereof, as compared with the prior art.

In an optional embodiment of the disclosure, if the main board of the display device receives the trigger signal transmitted by the pressure sensor in one of the LED lamp assemblies, but does not receive any trigger signal transmitted by the pressure sensor in the other LED lamp assembly, then the main board of the display device may control current in the other LED lamp assembly to be raised by 3% to 5%. The inventors of the application identified from a number of experiments that if the assembled light guide plate is offset to one of the LED lamp assemblies due to machining precision or positional precision, then current in the other LED lamp assembly can be controlled to be raised by 3% to 5% to thereby better alleviate the difference in brightness of pictures on both the sides of the backlight module so as to achieve a higher optical quality thereof.

The following two further situations may occur in a real product of the backlight module.

As illustrated in FIG. 5, the light guide plate 300 is positioned in the backlight module substantially symmetric horizontally to the two LED lamp assemblies 100, and there are gaps between the light entrance end faces of the light guide plate 300 and the pressure sensors 103, that is, the light guide plate 300 may not come into contact with the pressure sensor 103 on either of the sides. In this situation, there will not be any significant difference in brightness between both the sides of the backlight module, and the main board of the display device may control the current in the two LED lamp assemblies 100 to be maintained, if the main board does not receive any trigger signal transmitted by the pressure sensor 103 in either of the LED lamp assemblies 100.

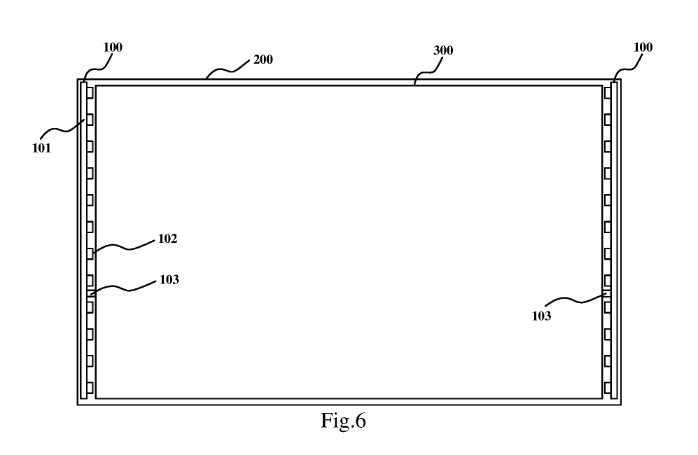

As illustrated in FIG. 6, the light guide plate 300 is positioned in the backlight module substantially symmetric horizontally to the two LED lamp assemblies 100, and both the light entrance end faces of the light guide plate 300 come into contact with the pressure sensors 103. In this situation, there will not be any significant difference in brightness between both the sides of the backlight module, and the main board of the display device may control the current in the two LED lamp assemblies 100 to be maintained, even upon reception of the trigger signals transmitted by the pressure sensors 103 in the LED lamp assemblies 100.

In the embodiment above of the disclosure, the two opposite light entrance end faces of the light guide plate 300 are located respectively on two short sides of the light guide plate 300, and the pressure sensor 103 in one of the two LED lamp assemblies 100 is positioned opposite to the pressure sensor 103 in the other LED lamp assembly. In a particular structure of the backlight module, the two opposite light entrance end faces of the light guide plate can alternatively be located on two long sides of the light guide plate.

An embodiment of the disclosure further provides a display device including the backlight module according to any one of the technical solutions above. Since there are a smaller difference in brightness of pictures throughout, and a higher optical quality, of the backlight module, the display device will also have a higher quality of display. The display device will not be limited to any particular type, e.g., a TV set, a liquid crystal display, a tablet computer, etc. If the embodiment of the disclosure can be applicable to a liquid crystal TV set with a large size, then the advantageous effect will become more pronounced.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. An LED lamp assembly, comprising a heat radiation substrate, and a plurality of LEDs arranged on the heat radiation substrate, wherein the LED lamp assembly further comprises at least one pressure sensor arranged on the heat radiation substrate on the same side as the plurality of LEDs arranged on the heat radiation substrate, and the pressure bearing face of the pressure sensor protrudes above the plurality of LEDs.

2. The LED lamp assembly according to claim 1, wherein a difference in height between the pressure bearing face of the pressure sensor and the plurality of LEDs ranges from 0.2 mm to 0.5 mm

3. The LED lamp assembly according to claim 1, wherein the pressure sensor comprises a piezoresistive pressure sensor or a strain gauge pressure sensor.

4. A backlight module, comprising a back plate, a light guide plate, and two LED lamp assemblies, wherein:
each LED lamp assembly comprises a heat radiation substrate, and a plurality of LEDs arranged on the heat radiation substrate, wherein each LED lamp assembly further comprises at least one pressure sensor arranged on the heat radiation substrate on the same side as the plurality of LEDs arranged on the heat radiation substrate, and the pressure bearing face of the pressure sensor protrudes above the plurality of LEDs, wherein:
the back plate comprises an accommodating space in which the light guide plate is located, and the two LED lamp assemblies are located respectively between two opposite light entrance end faces of the light guide plate and sidewalls of the back plate; and
the pressure sensor in each LED lamp assembly is connected by a signal with a main board of a display device, and configured to transmit a trigger signal to the main board of the display device when a pressure is applied thereto from one of the light entrance end faces of the light guide plate; and if the main board of the display device receives the trigger signal transmitted by the pressure sensor in one of the LED lamp assemblies, but does not receive any trigger signal transmitted by the pressure sensor in the other LED lamp assembly, then the main board of the display device controls current in the other LED lamp assembly to be raised.

5. The backlight module according to claim 4, wherein if the main board of the display device receives the trigger signal transmitted by the pressure sensor in one of the LED lamp assemblies, but does not receive any trigger signal transmitted by the pressure sensor in the other LED lamp assembly, then the main board of the display device controls current in the other LED lamp assembly to be raised by 3% to 5%.

6. The backlight module according to claim 4, wherein the main board of the display device controls current in the two LED lamp assemblies to be maintained, upon reception of the trigger signals transmitted by the pressure sensors in the two LED lamp assemblies.

7. The backlight module according to claim 4, wherein the main board of the display device controls current in the two LED lamp assemblies to be maintained, if the main board does not receive any trigger signal transmitted by the pressure sensor in either of the LED lamp assemblies.

8. The backlight module according to claim 4, wherein the two opposite light entrance end faces of the light guide plate are located respectively on two short sides of the light guide plate.

9. The backlight module according to claim 5, wherein the two opposite light entrance end faces of the light guide plate are located respectively on two short sides of the light guide plate.

10. The backlight module according to claim 6, wherein the two opposite light entrance end faces of the light guide plate are located respectively on two short sides of the light guide plate.

11. The backlight module according to claim 7, wherein the two opposite light entrance end faces of the light guide plate are located respectively on two short sides of the light guide plate.

12. The backlight module according to claim 8, wherein the pressure sensor in one of the two LED lamp assemblies is positioned opposite to the pressure sensor in the other LED lamp assembly.

13. The backlight module according to claim 9, wherein the pressure sensor in one of the two LED lamp assemblies is positioned opposite to the pressure sensor in the other LED lamp assembly.

14. The backlight module according to claim 10, wherein the pressure sensor in one of the two LED lamp assemblies is positioned opposite to the pressure sensor in the other LED lamp assembly.

15. The backlight module according to claim 11, wherein the pressure sensor in one of the two LED lamp assemblies is positioned opposite to the pressure sensor in the other LED lamp assembly.

16. A display device, comprising a backlight module, wherein the backlight module comprises a back plate, a light guide plate, and two LED lamp assemblies, wherein:
each LED lamp assembly comprises a heat radiation substrate, and a plurality of LEDs arranged on the heat radiation substrate, wherein each LED lamp assembly further comprises at least one pressure sensor arranged on the heat radiation substrate on the same side as the plurality of LEDs arranged on the heat radiation substrate, and the pressure bearing face of the pressure sensor protrudes above the plurality of LEDs, wherein:
the back plate comprises an accommodating space in which the light guide plate is located, and the two LED lamp assemblies are located respectively between two opposite light entrance end faces of the light guide plate and sidewalls of the back plate; and
the pressure sensor in each LED lamp assembly is connected by a signal with a main board of a display device, and configured to transmit a trigger signal to the main board of the display device when a pressure is applied thereto from one of the light entrance end faces of the light guide plate; and if the main board of the display device receives the trigger signal transmitted by the pressure sensor in one of the LED lamp assemblies, but does not receive any trigger signal transmitted by the pressure sensor in the other LED lamp assembly, then the main board of the display device controls current in the other LED lamp assembly to be raised.

17. The display device according to claim 16, wherein if the main board of the display device receives the trigger signal transmitted by the pressure sensor in one of the LED lamp assemblies, but does not receive any trigger signal transmitted by the pressure sensor in the other LED lamp assembly, then the main board of the display device controls current in the other LED lamp assembly to be raised by 3% to 5%.

18. The display device according to claim 16, wherein the main board of the display device controls current in the two LED lamp assemblies to be maintained, upon reception of the trigger signals transmitted by the pressure sensors in the two LED lamp assemblies.

19. The display device according to claim 16, wherein the main board of the display device controls current in the two LED lamp assemblies to be maintained, if the main board does not receive any trigger signal transmitted by the pressure sensor in either of the LED lamp assemblies.

20. The display device according to claim 16, wherein the two opposite light entrance end faces of the light guide plate are located respectively on two short sides of the light guide plate.
